(19) United States
(12) Patent Application Publication
(10) Pub. No.: US 2014/0021913 A1
(43) Pub. Date: Jan. 23, 2014

(54) VEHICLE BATTERY CHARGING SYSTEM AND METHOD

(71) Applicants: Douglas Raymond Martin, Canton, MI (US); William David Treharne, Ypsilanti, MI (US)

(72) Inventors: Douglas Raymond Martin, Canton, MI (US); William David Treharne, Ypsilanti, MI (US)

(73) Assignee: FORD GLOBAL TECHNOLOGIES, LLC, Dearborn, MI (US)

(21) Appl. No.: 13/553,465

(22) Filed: Jul. 19, 2012

(51) Int. Cl. H02J 7/00

(52) U.S. Cl. 320/109; 320/137; 320/148

(57) ABSTRACT

In at least one embodiment, a vehicle includes a battery and an inductive charge plate electrically connected with the battery. The vehicle further includes at least one controller configured to, in response to detecting an authenticated charge system, cause an initiation signal to be transmitted such that the charge system initiates charging of the battery via the charge plate and cause an association signal to be intermittently or continuously transmitted such that charging of the battery via the charge plate is maintained.

### TECHNICAL FIELD

This disclosure relates to the recharging of vehicle batteries.

### BACKGROUND

Charging methods for battery electric vehicles (BEV's) and plug in hybrid electric vehicles (PHEV's) have increased in prevalence as advancements in vehicle propulsion and battery technology have occurred.

### SUMMARY

In at least one embodiment, a vehicle is provided comprising a battery and an inductive charge plate electrically connected with the battery. The vehicle further includes at least one controller configured to, in response to detecting an authenticated charge system, cause an initiation signal to be transmitted such that the charge system initiates charging of the battery via the charge plate and cause an association signal to be intermittently or continuously transmitted such that charging of the battery via the charge plate is maintained.

In at least one embodiment, a vehicle is provided comprising a battery and an induction charge plate electrically connected with the battery. The vehicle further includes at least one controller configured to, in response to detecting a predefined condition of the battery while the battery is being charged according to a first charge procedure, cause a change signal to be transmitted such that a charge system charges the battery according to a second charge procedure via the charge plate and cause an association signal to be intermittently or continuously transmitted such that charging of the battery via the charge plate according to the second charge procedure is maintained.

In at least one embodiment, a method is provided for charging the battery of a vehicle. The method comprises detecting an authenticated charge system separate from and in proximity to the vehicle, and in response, causing an initiation signal to be transmitted such that the charge system initiates charging of the battery according to a charge procedure and causing an association signal to be intermittently or continuously transmitted such that charging of the battery according to the charge procedure is maintained.

### BRIEF DESCRIPTION OF THE DRAWINGS

FIG. 1 is a diagrammatic view of a vehicle docked at a charging station;

FIG. 2 is a flow chart of an algorithm for performing an initial wireless association between a vehicle and a vehicle charger; and

FIG. 3 is a flow chart of an algorithm for performing an ongoing wireless association between a vehicle and a vehicle charger.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Vehicles can be powered by battery electricity (BEVs) as well as by a combination of power sources including battery electricity. For example hybrid electric vehicles (HEVs) are contemplated in which the powertrain is powered by both a battery and an internal combustion engine. In these configurations, the battery is rechargeable and a vehicle charger provides power to restore battery after discharge.

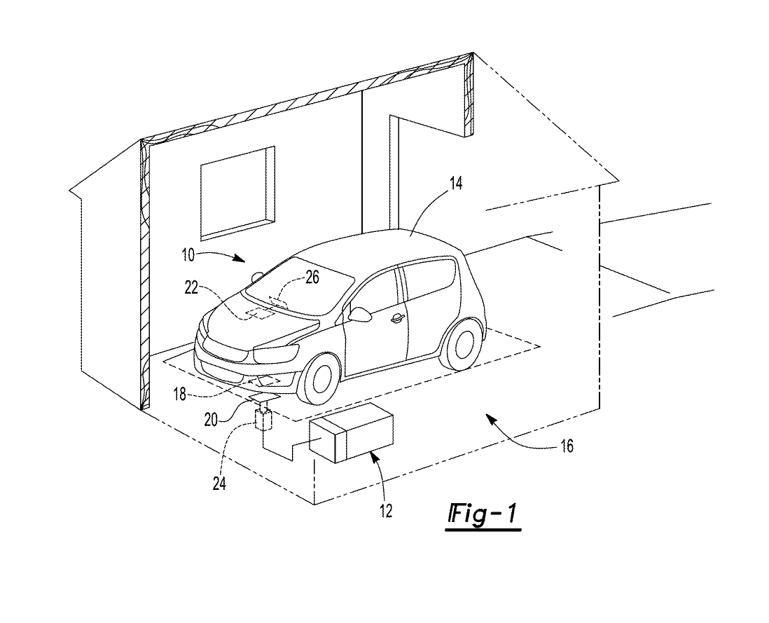

With reference to FIG. 1, a vehicle charge system is illustrated in accordance with one or more embodiments and is generally referenced by numeral 10. Induction charging is used to provide power from a charger 12 to a vehicle 14 in order to restore the battery. A charging station 16 is shown accommodating the vehicle 14 to be charged through induction charging. The vehicle 14 is shown as docked at the charging station 16 which houses the vehicle charger 12. The vehicle charger 12 can be connected to receive household electrical current, such as that available within a typical home garage.

The vehicle 14 includes a secondary coil housed within an induction charge plate 18 disposed on the underside of the vehicle 14. The vehicle secondary induction charge plate 18 is electrically connected to the vehicle battery. The vehicle 14 also includes an AC to DC power converter in order to rectify and filter the AC power received from the vehicle charger 12 into DC power to be received by the battery. The vehicle charger 12 is disposed in the floor beneath the vehicle 14, and includes a primary charging coil housed within a corresponding primary induction charging plate 20. The primary induction charging plate 20 can be generally horizontal and offset to the vehicle secondary induction charge plate 18. The primary induction charging plate 20 can further be articulable in height to create a suitable gap to facilitate charging of the vehicle 14. Electrical current is provided to the primary coil, which generates an electromagnetic field around the primary induction charging plate 20. When the vehicle secondary induction charge plate 18 is in proximate relation to the powered primary induction charging plate 20, it receives power by being within the generated electromagnetic field. Current is induced in the secondary coil and subsequently transferred to the vehicle battery, causing a recharging effect. The gap between the plates allows for variation in vehicle alignment, and also for accommodation of alternate authorized vehicles with differing ride heights.

In an alternative embodiment (not shown), the charging station primary induction charging plate is configured to be in a generally upright position, for example on or near a wall. The vehicle would have a corresponding secondary induction charge plate on a front or rear vertical portion, for example as part of a front or rear bumper. The primary and secondary induction charging plates come in to a proximate relation when the vehicle is driven to the charge station, and parked in a designated charging position. Partly related to variation of the park position of the vehicle, an intentional gap would again be provided between the primary and secondary induction charge plates.

Referring back to FIG. 1, the vehicle 14 is provided with a controller 22. Although it is shown as a single controller, the vehicle controller 22 can include multiple controllers that are used to control multiple vehicle systems. For example, the vehicle controller 22 can be a vehicle system controller/powertrain control module (VSC/PCM). In this regard, the vehicle charging control portion of the VSC/PCM can be software embedded within the VSC/PCM, or it can be a separate hardware device. The vehicle controller 22 generally includes any number of microprocessors, ASICs, ICs, memory (e.g., FLASH, ROM, RAM, EPROM and/or EEPROM) and software code to co-act with one another to perform a series of operations. A microprocessor within the vehicle controller 22 further includes a timer to track given time intervals between a time reference and selected events. Designated intervals are programmed such that the controller provides certain commands signals and monitors given inputs at selectable time intervals. The vehicle controller is in electrical communication with the vehicle battery, and receives signals to indicate the battery charge level. The vehicle controller 22 further communicates with other controllers over a hardline vehicle connection using a common bus protocol (e.g., CAN), and also employs wireless communication.

The vehicle charger 12 is provided with a charger controller 24 having wireless communication means. The charger controller 24 similarly has embedded software and is programmable to regulate power flow provided by the vehicle charger 12. Software included with the charger controller 24 also includes a timer to track elapsed time between designated events. Under selected conditions, or upon the receipt of designated instructions, the charger controller 24 can enable, disable, or reduce power flow through the charger 12. The vehicle charger 12 is configured to receive signals indicative of charge instructions from the vehicle controller 22.

The vehicle controller 22 is configured to wirelessly communicate with the charger controller 24. The wireless communication can be accomplished through RFID, NFC, Bluetooth, or other wireless methods. In at least one embodiment, said wireless communication is used to complete an association procedure between the vehicle 14, and the vehicle charger 12 prior to initiating a charge procedure. The association procedure can include the vehicle controller 22 sending a signal to the charger controller 24 indicating a request for authentication. The controller 22 then receives a response signal from the charger controller 24, and uses the response signal to determine whether or not to grant an initial authenticated status to the vehicle charger 12. Authentication can be influenced by a number of designated factors including manufacturer, power ratings, security keys, and/or other authentication factors. Based on an appropriate response signal by the charger controller 24, the vehicle controller 22 determines an affirmative association between the vehicle 14 and the vehicle charger 12. Once an authenticated charger is detected, the vehicle controller 22 provides an initiation signal to the charger controller 24 to instruct the charge system to initiate a charge procedure. The initial wireless request and subsequent authentication response make up an association “handshake” between the two devices. The association also provides for further secure communication and command signals between the vehicle 14 and the vehicle charger 12. If no affirmative authentication response is received by the vehicle controller 22, a command signal may be provided to prevent charging.

The vehicle charger 12 is further configured to require an ongoing or periodic transmission of a signal from the vehicle 14 to preserve an affirmative association and maintain a charge procedure. The vehicle controller 22 can cause an association signal to be transmitted intermittently, or transmitted continuously. In at least one embodiment, a repeated transmission of the association signal occurs at predetermined time intervals. The initiation and/or conclusion of the association signal can also be triggered by charging related events, for example such as designated threshold battery charge levels, or predetermined cumulative energy thresholds delivered by the vehicle charger. The charger controller 24 is programmable to terminate association and shut off power to the primary induction charging plate 20 if no signal is received from the vehicle within designated time intervals. In this way, power is not expended by the vehicle charger 12 if no vehicle is present to receive a charge. For example, a vehicle 14 transmission shift into a torque enabled state, such as drive or reverse, triggers an interruption of the ongoing of association signals sent by the vehicle controller 22. Additionally, an explicit charge termination signal can be provided to disable the vehicle charger 12. Power supplied to the primary induction charge plate 20 would then be terminated. Therefore if a driver were to drive away and depart from the charging station 16 during a charge procedure, an automated shut off of the vehicle charger 12 would occur.

Ongoing association between the vehicle 14 and the charger 12 at intervals can also be a suitable method to discontinue a charge procedure upon achieving certain threshold battery charge levels. The vehicle controller 22 is programmable to stop performing association procedures upon a designated threshold charge level of the vehicle battery. A threshold charge level which is a full or less than full charge, can be selected to trigger an interruption in the ongoing association procedure. As discussed above, power to the induction charge plate 20 is disabled once the vehicle charger 12 stops receiving the ongoing association signal. Further, a substantially full battery charge threshold level can prompt the vehicle controller 22 to provide commands for the vehicle charger to enter a reduced current charge procedure or a trickle current charge procedure.

In alternative embodiments, the vehicle controller 22 is further configured to control an on-vehicle switch in the charging circuit. The vehicle controller 22 disables charging by opening the circuit connected to the secondary induction charge plate 18 to prevent inductive current flow into the vehicle 14.

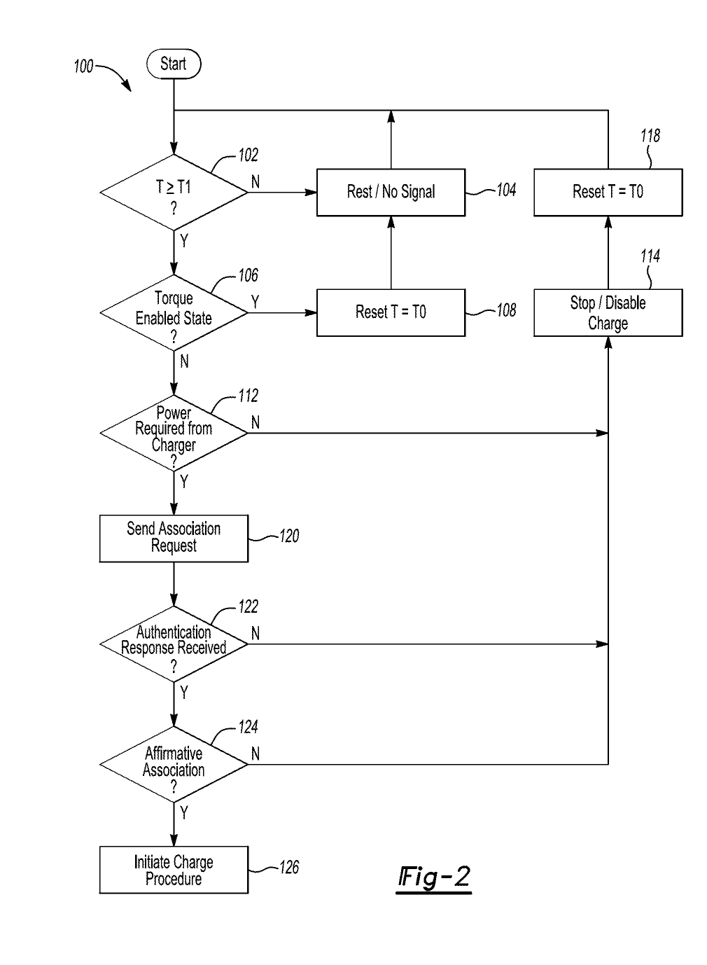

According to FIG. 2, a method 100 is illustrated whereby a vehicle controller performs an association procedure according to at least one embodiment of the present invention. The algorithm starts at step 102 where the controller considers whether the designated time interval T1 has elapsed between the current time and an initial time reference T0. If not, the controller remains in a rest state in step 104 and provides no command signal pertaining to vehicle charging. The controller then returns to step 102 to re-consider the current time elapsed from the time reference T0 relative to the designated time interval T1.

If the vehicle controller determines in step 102 that time interval T1 has been reached, the controller then considers in step 106 whether or not the vehicle is in a torque enabled state. If the vehicle is in a torque enabled state, the controller resets the time tracking back to time reference T0 in step 108. The controller would then enter a rest state in step 104, and further return to step 102. This sequence allows for the charging portion of the controller to remain at rest during active driving. The sequence further allows an operator to shift the vehicle out of park and reenter park, and subsequently reactivate a vehicle charge sequence.

If the vehicle controller determines in step 106 that the vehicle is not in a torque enabled state, the controller then determines in step 112 whether the vehicle requires power from the charger. The requirement can be based on the current battery charge level in relation to a threshold charge level. If the battery charge level is less than the threshold charge level, power is required from the vehicle charger. Alternatively, power may be required from the charger to facilitate other vehicle activities while the vehicle is docked at the charging station. For example, power may be drawn from the vehicle charger to thermally heat or cool the battery as required. A power draw can also occur for the purpose of heating or cooling the passenger compartment of the vehicle. If the no power is required from the vehicle charger, the controller provides in step 114 an instruction to disable the vehicle charger from providing power. The time tracking is then reset in step 118 to the time reference T0, and the controller returns to step 102.

If power is required from the vehicle charger in step 112, for example when the battery charge level is less than the threshold charge level, the controller provides in step 120 a wireless signal indicating an association request. The vehicle controller then awaits a subsequent response signal from the charger. If no response is received in step 122, the controller provides instruction to disable the vehicle charger from providing power in step 114, resets the time tracking in step 118, and further returns to step 102.

Once a wireless response is received from the vehicle charger in step 122, the vehicle controller determines in step 124 whether the charger is an authorized device. If no authorization is determined in step 124, the charger is disabled from providing power in step 114. The timer is then reset to T0 in step 118, and the controller returns to step 102.

Provided that an authorized charging source has been determined in step 124, the vehicle initiates a charge procedure in step 126, enabling power flow and further procedure command signals between the vehicle and the charger.

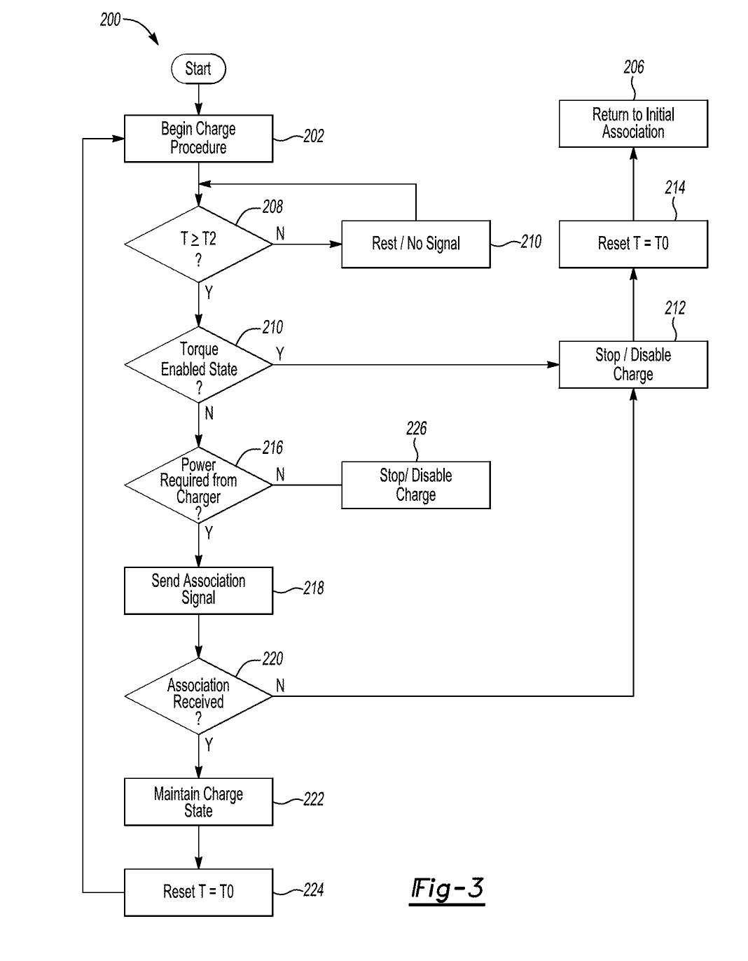

An additional method, depicting an ongoing association procedure, is illustrated in FIG. 3 generally as method 200. Step 202 initially begins a charge procedure, for example, as an outcome of method 100 described above. The vehicle controller then determines in step 208 whether the designated time interval T2 has elapsed between the current time and the initial time reference T0. If not, the controller remains in a rest state in step 210 and provides no command signal to the charger pertaining to vehicle charging. The controller then returns to step 208 to re-consider the current time elapsed from the time reference T0 relative to the designated time interval T2. It should be appreciated that the time interval T2 can comprise a shorter duration than the time interval T1. Further, T2 may be short enough to approximate a continuous association between the vehicle and the charger.

Once the designated time interval T2 has elapsed, the vehicle controller determines in step 210 whether the vehicle is in a torque enabled state. If the vehicle is torque enabled, the vehicle controller provides in step 212 a signal indicative of a command to stop or disable the vehicle charger. The controller would then reset the timer in step 214 to the time reference T0, and subsequently return in step 206 to an initial association procedure.

If the vehicle is not torque enabled, for example in a parked state in step 210, the vehicle controller then determines in step 216 whether the vehicle requires power from the charger. If the vehicle battery charge level exceeds a designated threshold, and if there is no need to power other vehicle activities while docked at the charging station, the vehicle controller provides in step 226 a signal indicative of a command to disable or the vehicle charger. It should be appreciated that the threshold charge level of the ongoing association procedure may or may not be the same level as that of the initial association procedure.

If either the battery charge level is less than the designated threshold charge level, or if the vehicle requires power from the charger to facilitate vehicle activities in step 216, the vehicle controller causes in step 218 an association signal to be transmitted to the vehicle charger. The association signal transmitted in step 218 reaffirms any prior association, and maintains a given charge procedure. If the signal is not received by the vehicle charger in step 220, either the vehicle controller or the charger controller can be configured to discontinue charging in step 212 since the time interval T2 has elapsed and no signal affirming association has been received. The controller(s) would then reset the timer in step 214 to the time reference T0, and subsequently return in step 206 to an initial association procedure.

Once the vehicle charger receives the association signal in step 220, continuance of the charge procedure is enabled and the charge state is maintained in step 222. The controller(s) then resets the timer in step 224, and returns to step 202. Depending on the duration of T2, the association signal can be considered to be transmitted either intermittently or continuously as the vehicle controller cycles through method 200.

In an alternative embodiment, additional battery charge level thresholds are stored as predefined conditions within the vehicle controller to enable further charge procedure functions. Different charge level thresholds are designated such that a switch between charge procedures occurs when the charge level is achieved. When the vehicle battery is near a full discharge, a higher current is advantageous to reduce recharge time. In contrast, at a substantially full charge, providing the vehicle battery with a low current, or an intermittent current, can be advantageous to prevent battery discharge prior to the next vehicle use. A distinguishing aspect between some of the selectable charge procedures is to provide different amounts of current to the battery per unit time. The vehicle controller determines an appropriate procedure depending at least on the charge level of the battery relative to a predefined charge level threshold. If a charge procedure is underway, the vehicle controller provides a change signal indicative of a command to the charge system to change to a different appropriate charge procedure. Each of the procedures benefits from ongoing communicative association between the vehicle and the charger to maintain the procedure.

A possible advantage of the above methods is to provide control systems for wireless inductive charging that provide both an initial association, and ongoing association between a vehicle and a charger. Certain events are selected to interrupt charge procedures when desirable through requiring ongoing association communication. As mentioned above, vehicle drive off events, a substantially fully charged battery, and other prescribed events can trigger the discontinuance of ongoing association signals such that power to the vehicle charger is disabled.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a battery;
a charge plate electrically connected with the battery; and
at least one controller configured to, in response to detecting an authenticated charge system, (a) cause an initiation signal to be transmitted such that the charge system initiates charging of the battery via the charge plate and (b) cause an association signal to be intermittently or continuously transmitted such that charging of the battery via the charge plate is maintained.

2. The vehicle of claim 1, wherein the at least one controller is further configured to cause the association signal to be transmitted at predetermined time intervals.

3. The vehicle of claim 1, wherein the at least one controller is further configured to cause the intermittent or continuous transmission of the association signal to be interrupted in response to the vehicle being shifted into a torque enabled state such that the charge system discontinues charging of the battery via the charge plate.

4. The vehicle of claim 1, wherein the at least one controller is further configured to cause the intermittent or continuous transmission of the association signal to be interrupted in response to the battery achieving a threshold charge level such that the charge system discontinues charging of the battery via the charge plate.

5. The vehicle of claim 1, wherein the at least one controller is further configured to cause a termination signal to be transmitted in response to the battery achieving a threshold charge level such that the charge system discontinues charging of the battery via the charge plate.

6. The vehicle of claim 1, wherein the at least one controller is further configured to cause a termination signal to be transmitted in response to the vehicle being shifted into a torque enabled state such that the charge system discontinues charging of the battery via the charge plate.

7. A vehicle comprising:
a battery;
a charge plate electrically connected with the battery; and
at least one controller configured to, in response to detecting a predefined condition of the battery while the battery is being charged by a charge system via the charge plate according to a first charge procedure, (a) cause a change signal to be transmitted such that the charge system charges the battery according to a second charge procedure via the charge plate and (b) cause an association signal to be intermittently or continuously transmitted such that charging of the battery via the charge plate according to the second charge procedure is maintained.

8. The vehicle of claim 7, wherein the at least one controller is further configured to cause the association signal to be transmitted at predetermined time intervals.

9. The vehicle of claim 7, wherein the at least one controller is further configured to cause the intermittent or continuous transmission of the association signal to be interrupted in response to the vehicle being shifted into a torque enabled state such that the charge system discontinues charging of the battery via the charge plate.

10. The vehicle of claim 7, wherein the at least one controller is further configured to cause the intermittent or continuous transmission of the association signal to be interrupted in response to the battery achieving a threshold charge level such that the charge system discontinues charging of the battery via the charge plate.

11. The vehicle of claim 7, wherein the at least one controller is further configured to cause a termination signal to be transmitted in response to the battery achieving a threshold charge level such that the charge system discontinues charging of the battery via the charge plate.

12. The vehicle of claim 7, wherein the at least one controller is further configured to cause a termination signal to be transmitted in response to the vehicle being shifted into a torque enabled state such that the charge system discontinues charging of the battery via the charge plate.

13. The vehicle of claim 7, wherein charging the battery according to the second charge procedure provides a different amount of current to the battery per unit time than charging the battery according to the first charge procedure.

14. A method for charging a battery of a vehicle comprising:
detecting an authenticated charge system separate from and in proximity to the vehicle; and
in response, (a) causing an initiation signal to be transmitted such that the charge system initiates charging of the battery according to a charge procedure and (b) causing an association signal to be intermittently or continuously transmitted such that charging of the battery according to the charge procedure is maintained.

15. The method of claim 14 further comprising causing the intermittent or continuous transmission of the association signal to be interrupted in response to the vehicle being shifted into a torque enabled state such that charging of the battery according to the charge procedure is discontinued.

16. The method of claim 14 further comprising causing the intermittent or continuous transmission of the association signal to be interrupted in response to the battery achieving a threshold charge level such that charging of the battery according to the charge procedure is discontinued.

17. The method of claim 14 further comprising causing a termination signal to be transmitted in response to the vehicle being shifted from a parked state such that charging of the battery according to the charge procedure is discontinued.

18. The method of claim 14 further comprising causing a termination signal to be transmitted in response to the battery achieving a threshold charge level such that charging of the battery according to the charge procedure is discontinued.
